(19) United States
(12) Patent Application Publication
(10) Pub. No.: US 2009/0193299 A1
(43) Pub. Date: Jul. 30, 2009

(54) MEDICAL SUPPORT CONTROL SYSTEM

(76) Inventors: Kiyoshi SEKIGUCHI, Tokyo (JP); Masaru ITO, Yokohama (JP); Koichi TASHIRO, Sagamihara (JP); Masahide YAMAKI, Tokyo (JP); Nobuyuki FURUKAWA, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/021,897

(22) Filed: Jan. 29, 2008

(51) Int. Cl. G06F 11/07

(52) U.S. Cl. 714/48; 714/E11.024

(57) ABSTRACT

A medical support control device to which are connected a display manipulation device and a medical device control device connected to a medical device and controlling the medical device, comprising: a detection unit for detecting abnormality in an image signal line outputting an image signal to the display manipulation unit; and an interruption unit for interrupting communications to the medical device control device in accordance with the detection unit.

### BACKGROUND OF THE INVENTION

1. Field of the Invention

The present invention relates to a medical support control system for controlling medical devices and non-medical devices used for operations.

2. Description of the Related Art

Operating systems using medical controllers or the like for controlling medical devices such as endoscopes or the like used for operations have been proposed. Medical devices to be controlled such as electric knives, aeroperitoneum devices, endoscope cameras, light source devices, or the like are connected to the medical controller (also referred to as MC). Also, a display device, a manipulation panel, or the like is connected to the MC. The manipulation panel includes a display unit and a touch sensor, and is used as a central manipulation device by nurses or the like working in an unsterilized area. The display device is used for displaying endoscope images or the like.

There is audio-visual equipment in the operating room such as a room light, a room camera, an interphone device, a liquid crystal display device, or the like (non-medical devices). The audio-visual equipment is controlled independently or by a non-medical controller (also referred to as an NMC) used for the central control.

Japanese Patent Application Publication No. 2006-000536, for example, discloses an operating system, comprising: a first controller connected to a medical device provided in an operating room; a second controller connected to a non-medical device provided in the operating room; and manipulation instruction input means transmitting the content of a manipulation instruction to the first controller when the manipulation instruction to the medical device or the non-medical device is input. The first controller transmits to the second controller a first control signal in accordance with the manipulation instruction of the non-medical device input into the manipulation instruction means. The second controller converts the first control signal into a second control signal used for controlling the non-medical device, and transmits the second control signal to the non-medical device. Thereby, the operating system and a non-medical system work together, and the operating person himself/herself or the like can manipulate the non-medical devices.

### SUMMARY OF THE INVENTION

A medical support control device according to the present invention, to which are connected a display manipulation device and a medical device control device connected to a medical device and controlling the medical device, comprises:

a detection unit for detecting abnormality in an image signal line outputting an image signal to the display manipulation unit; and

an interruption unit for interrupting communications to the medical device control device in accordance with the detection unit.

A medical support control system according to the present invention comprises:

a medical device control device connected to a medical device and controlling the medical device;

a display manipulation device; and

a medical support control device to which the medical device control device and the display manipulation device are connected, wherein:

the medical support control device comprises:
a detection unit for detecting abnormality in an image signal line outputting an image signal to the display manipulation device; and
an interruption unit for interrupting communications to the medical device control device in accordance with the detection unit.

### BRIEF DESCRIPTION OF THE DRAWINGS

FIG. 1 shows an entire configuration of the medical device control system according to the present embodiment;

FIG. 2 is a block diagram showing an entire configuration of a medical support control system 100 according to the present embodiment;

FIG. 3 is a block diagram showing a configuration of an NMC 202 according to the present embodiment;

FIG. 4A is a first figure showing a switching operation of a control target between the NMC 202 and an MC 114 performed by a TP control switching unit 305;

FIG. 4B is a second figure showing the switching operation of a control target between the NMC 202 and the MC 114 performed by the TP control switching unit 305; and

FIG. 5 shows interruption of communications, according to the present embodiment, through a TP coordinate communication line to the MC 114 and the NMC 202 in a case in which the TP image line is disconnected.

### DESCRIPTION OF THE PREFERRED EMBODIMENTS

Hereinafter, the embodiments of the present invention will be explained in detail, referring to the drawings.

A medical support control system according to the present embodiment includes a medical device control system and a non-medical device control system. The medical device control system includes a plurality of medical devices and a medical controller for controlling these medical devices. The non-medical device control system includes non-medical devices (that may further include medical devices) that are used for operations, and a non-medical controller for controlling these non-medical devices.

An endoscopic operating system will be explained as an example of the medical device control system.

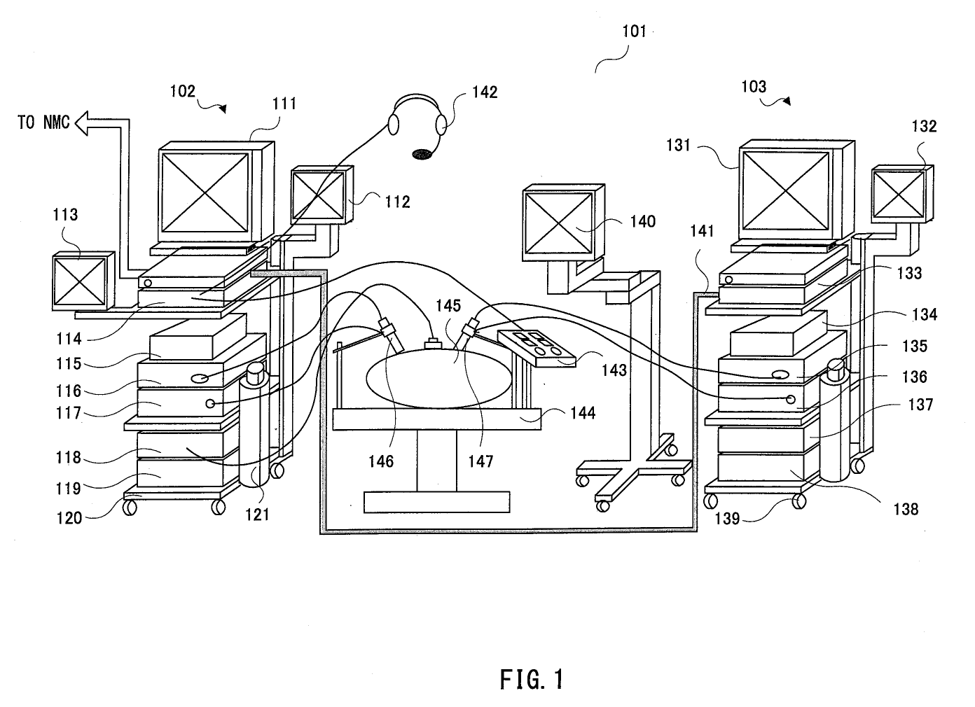

FIG. 1 shows an entire configuration of the medical device control system according to the present embodiment. An endoscopic operating system is shown as a medical device control system 101. In the operating room, a first endoscopic operating system 102 and a second endoscopic operating system 103 beside a bed 144 on which a patient 145 is laid and a wireless remote controller 143 for the operating person are provided.

The endoscopic operating systems 102 and 103 respectively have first and second trolleys 120 and 139 each including a plurality of endoscope peripheral devices used for observation, examination, procedures, recoding, and the like. Also, an endoscope image display panel 140 is arranged on a movable stand.

On the first trolley 120, an endoscope image display panel 111, a central display panel 112, a central manipulation panel device 113, a medical controller (MC) 114, a recorder 115, a video processor 116, an endoscope light source device 117, an insufflation unit 118, and an electrical surgical device 119 are arranged.

The central manipulation panel device 113 is arranged in a unsterilized area to be used by nurses or the like in order to manipulate the respective medical devices in a centralized manner. This central manipulation panel device 113 may include a pointing device such as a mouse, a touch panel, or the like (not shown). By using the central manipulation panel device 113, the medical devices can be managed, controlled, and manipulated in a centralized manner.

The respective medical devices are connected to the MC 114 via communication cables (not shown) such as serial interface cables or the like, and can have communications with one another.

Also, a headset-type microphone 142 can be connected to the MC 114. The MC 114 can recognize voices input through the headset-type microphone 142, and can control the respective devices in accordance with the voices of the operating person.

The endoscope light source device 117 is connected to a first endoscope 146 through a light-guide cable used for transmitting the illumination light. The illumination light emitted from the endoscope light source device 117 is provided to the light guide of the first endoscope 146 and illuminates the affected areas or the like in the abdomen of the patient 145 into which the insertion unit of the first endoscope 146 has been inserted.

The optical image data obtained through the camera head of the first endoscope 146 is transmitted to a video processor 116 through a camera cable. The optical image data undergoes signal processing in a signal processing circuit in the video processor 116, and the video signals are created.

The insufflation unit 118 provides CO₂ gas to the abdomen of the patient 145 through a tube. The CO₂ gas is obtained from a gas tank 121.

On the second trolley 139, an endoscope image display panel 131, a central display panel 132, a expansion unit 133, a recorder 134, a video processor 135, an endoscope light source device 136, and other medical devices 137 and 138 (such as an ultrasonic processing device, a lithotripsy device, a pump, a shaver, and the like) are arranged. These respective devices are connected to the expansion unit 133 through cables (not shown), and can communicate with one another. The MC 114 and the expansion unit 133 are connected to each other through the expansion cable 141.

The endoscope light source device 136 is connected to a second endoscope 147 through the light-guide cable for transmitting the illumination light. The illumination light emitted from the endoscope light source device 136 is provided to the light guide of the second endoscope 147, and illuminates the affected areas or the like in the abdomen of the patient 145 into which the insertion unit of the second endoscope 147 has been inserted.

The optical image data obtained through the camera head of the second endoscope 147 is transmitted to a video processor 135 through a camera cable. The optical image data undergoes signal processing in a signal processing circuit in the video processor 135, and the video signals are created. Then, the video signals are output to the endoscope image display panel 131, and endoscope images of the affected areas or the like are displayed on the endoscope image display panel 131.

Further, the MC 114 can be controlled by the operating person manipulating the devices in the unsterilized area. Also, the first and second trolleys 120 and 139 can include other devices such as printers, ultrasonic observation devices, or the like.

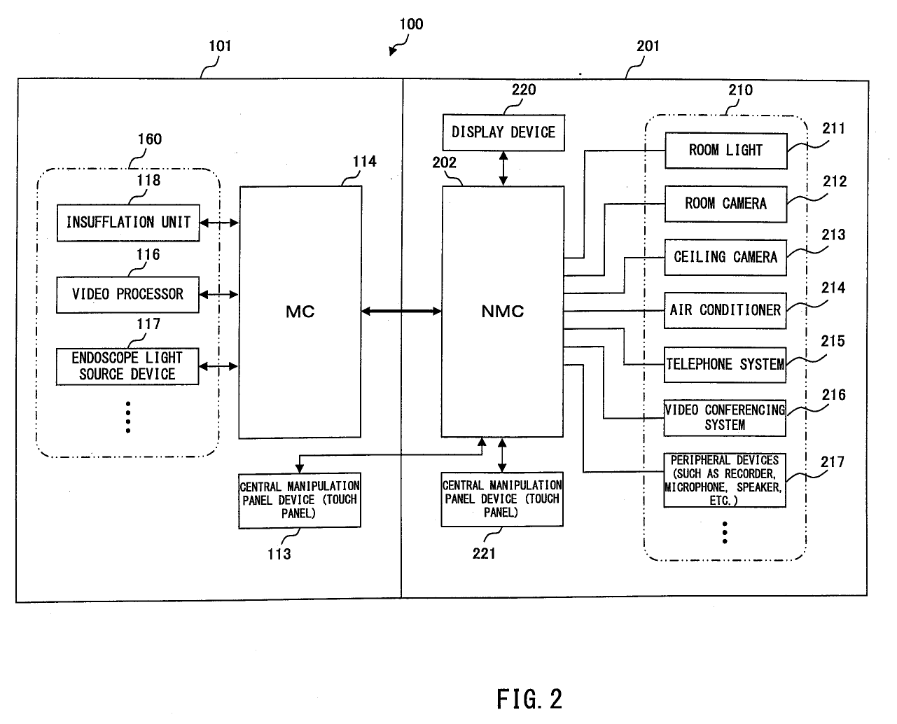

FIG. 2 is a block diagram showing an entire configuration of a medical support control system 100 according to the present embodiment. As described above, the medical support control system 100 includes the medical device control system 101 and a non-medical device control system 201. A detailed configuration of the medical device control system 101 is as shown in FIG. 1. However, in FIG. 2, the medical device control system 101 is shown in a simplified manner for simplicity of explanation.

In FIG. 2, a medical device group 160 is a group of medical devices that are directly connected to the medical controller 114 or are indirectly connected to the MC 114 via the expansion unit 133. Examples of the devices included in the medical device group 160 are the insufflation unit 118, the video processor 116, the endoscope light source device 117, the electrical surgical device 119, and the like.

The central manipulation panel device 113 has a touch panel, and in accordance with the information input into the touch panel, the devices connected to the MC 114 or a non-medical device controller (NMC) 202 that will be described later can be manipulated.

The non-medical control system 201 includes the NMC 202 connected to the MC 114 through a communication cable or the like, and a non-medical device group 210. In this configuration, the NMC 202 can transmit and receive, through an image cable, the video signals to and from the medical device group 160 connected to the MC 114.

The NMC 202 controls the non-medical devices (including the audio-visual devices) connected thereto. As shown in FIG. 2, the non-medical device group 210 connected to the NMC 202 according to the present embodiment consists of a room light 211, a room camera 212, a ceiling camera 213, an air conditioner 214, a telephone system 215, a conference system 216 to be used for individuals in remote places (referred to as a video conference system hereinafter), and other peripheral devices 217. Further, a display device 220 and a central manipulation panel device 221 are connected to the NMC 202.

Also, the non-medical device group 210 includes equipment such as light devices provided in the operating room in addition to the AV devices used for recording and reproducing image data.

The display device 220 is a plasma display panel (PDP) or a liquid crystal display (LCD) device, and displays images of the predetermined device or images of the devices selected by nurses or the like through the central manipulation panel device 221. The room light 211 is a device that illuminates the operating room. The room camera 212 is used for shooting images of the situations in the operating room. The ceiling camera 213 is a camera suspended from the ceiling whose positions can be changed. The conference system 216 is a system that displays images and transmits voices of nurses or the like in the medical office or the nurse stations, and enables conversations with them. The peripheral devices 217 are, for example, a printer, a CD player, a DVD recorder, and the like. The central manipulation panel device 221 has a touch panel that is the same as that included in the central manipulation panel device 113, and controls the respective AV devices connected to the NMC 202. The central manipulation panel devices 113 and 221 are referred to as TPs hereinafter.

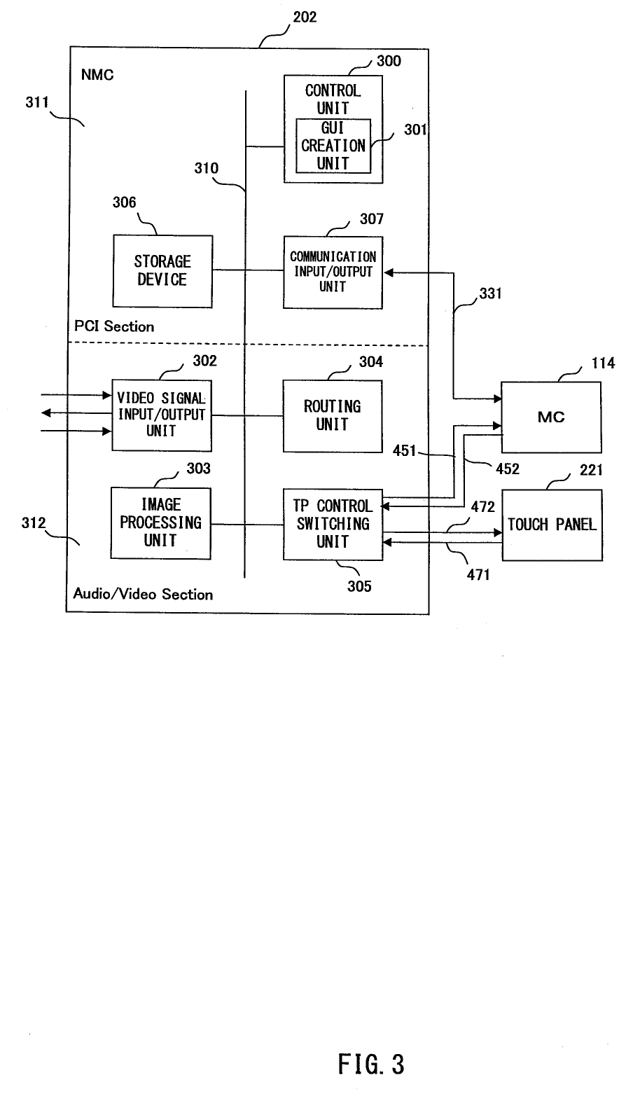

FIG. 3 is a block diagram showing a configuration of the NMC 202 in the present embodiment. The NMC 202 includes a PCI section 311 and an audio/video (A/V) section 312.

The PCI section 311 mainly controls a non-medical device group 210 connected to the NMC 202. The PCI section 311 includes a control unit 300, a storage device 306, and a communication input/output unit 307. The control unit 300 controls the entirety of the PCI section 311, and transmits and receives data to and from the A/V section 312. The control unit 300 has a GUI creation unit 301 and the like. Numerical symbol 310 denotes a backplane.

The GUI creation unit 301 creates Graphical User Interface image information (hereinafter referred to as GUI image information) that is an image layout to be displayed on a TP 221 or a monitor device, and transmits it to a routing unit 304.

The storage device 306 stores various programs, information set by the TP 221, and the like.

The communication input/output unit 307 is a communication interface used for the communications with the MC 114 via a communication line 331. The NMC 202 and the MC 114 monitor each other via the communication line 331 and synchronize each other's GUI environment.

The A/V section 312 is a section that mainly processes the video signals and the audio signals. The A/V section 312 includes a video signal input/output unit 302, an image processing unit 303, a routing unit 304, and a TP control switching unit 305.

The video signal input/output unit 302 has a plurality of video signal input ports and a plurality of video signal output ports.

The routing unit 304 switches routes for the video signals that were processed in the image processing unit 303 and the video signals input from the video signal input/output unit 302, and transfers them to a prescribed configuration unit in the NMC 202. Also, the routing unit 304 transfers to the TP control switching unit 305 the GUI image information created in the GUI creation unit 301.

The image processing unit 303 performs image processing on the image information transferred from the routing unit 304. Examples of the image processing are enlargement/reduction (scaling) of images, mirroring of images, rotation of images, displaying another and small image in a main image (picture in picture (PIP)), and displaying a plurality of images simultaneously (picture out picture (POP)).

TP coordinate communication lines 451 and 471 are communication lines through which TP coordinate signals generated by touch manipulations on the TP 221 are conveyed. TP image lines 452 and 472 are image lines through which image signals such as GUI images or the like to be displayed on the TP 221 are conveyed.

The TP control switching unit 305 synthesizes the GUI image created in the GUI creation unit 301 with images created on the basis of the video signals transmitted from the video signal input/output unit 302. Then, the TP control switching unit 305 outputs the synthesized image to the TP 221. Further, the TP control switching unit 305 can perform switching between the NMC 202 and the MC 114 as the manipulation targets of the TP 221. In other words, the TP control switching unit 305 receives TP coordinate information of the TP 221 obtained from the TP 221, transfers the received TP coordinate information to the control unit 300, or transfers the TP coordinate information to the MC 114 when the touch manipulation is performed.

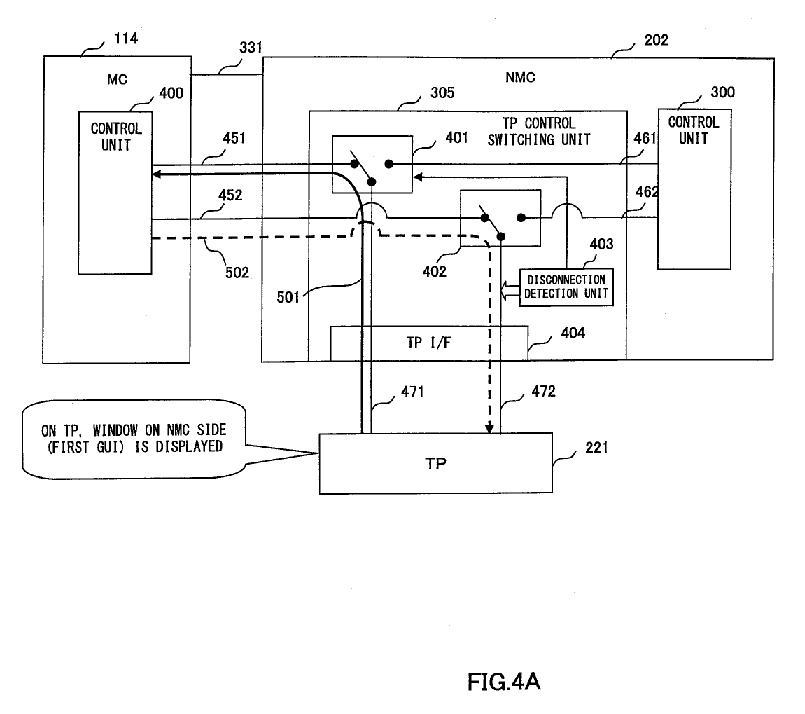

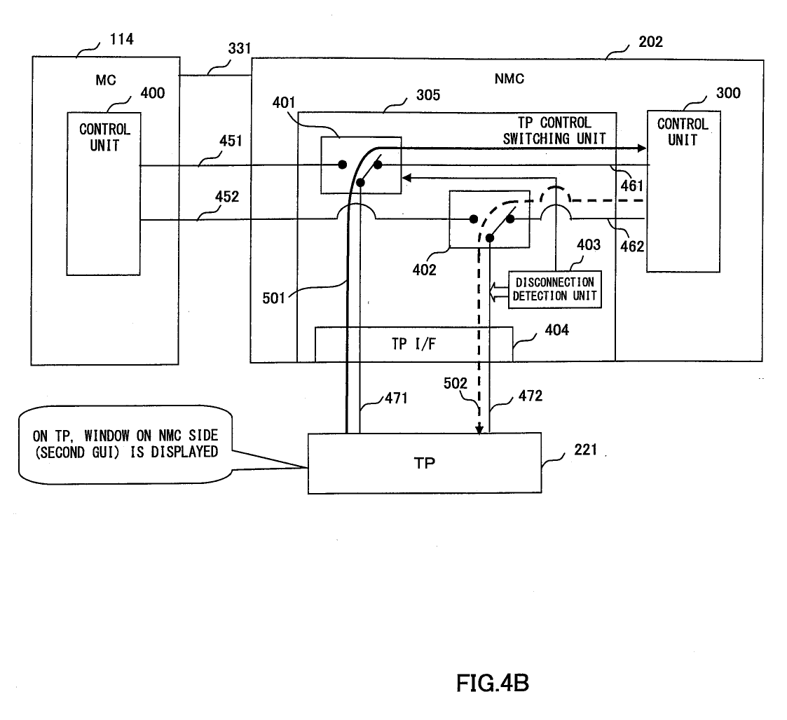

FIGS. 4A and 4B respectively show the switching of the control targets between the NMC 202 and the MC 114 by using the TP control switching unit 305.

As described above, the MC 114 is a controller mainly for medical devices. The MC 114 creates a graphical user interface (first GUI) that is a window used for controlling the medical devices belonging to the MC 114 itself.

As described above, the NMC 202 is a controller mainly for non-medical devices. The NMC 202 creates a graphical user interface (second GUI) that is a window used for controlling the non-medical devices belonging to the NMC 202 itself.

The first and second GUIs are designed on the basis of a common graphical user interface (common GUI). For example, by switching the tabs on a window on the TP, the first and second GUIs can be switched therebetween.

The TP coordinate communication lines 451, 461, and 471 are communication lines used for transmitting the TP coordinate signals of the TP 221 to a control unit 400 of the MC 114 or to the control unit 300 of the NMC 202.

The TP image lines 452, 462, and 472 are image lines for transmitting images such as the first or second GUI to be displayed on the TP 221 from the control unit 400 of the MC 114 to the TP 221 or from the control unit 300 of the NMC 202 to the TP 221.

The TP control switching unit 305 has a TP coordinate communication line switch 401, a TP image line switch 402, a disconnection detection unit 403, and a TP I/F 404.

The TP I/F 404 is an interface to which the TP image line and the TP coordinate communication lines used for connecting the TP 221 and the NMC 202 are connected.

The TP coordinate communication line switch 401 is used for determining whether the TP coordinate communication line 471 is to be connected to the TP coordinate communication line 451 on the MC 114 or to the TP coordinate communication line 461 on the NMC 202 side.

The TP image line switch 402 is used for determining whether the TP image line 472 is to be connected to the TP image line 452 on the MC 114 side or to the TP image line 462 on the NMC 202 side.

The disconnection detection unit 403 detects disconnection of the TP image line 472 by detecting the states of voltage being applied to the TP image line 472 or the voltage value in the TP image line 472. The disconnection detection unit 403 reports the detection results to the TP coordinate communication line switch 401.

Explanations will be given for a case, shown in FIG. 4A, in which the TP coordinate communication line 451 is selected by the TP coordinate communication line switch 401 and the TP image line 452 is selected by the TP image line switch 402. ATP image signal 502 generated in the control unit 400 is input into the TP 221 via the TP image line switch 402, and the first GUI is displayed on the TP 221. In this case, a TP coordinate signal 501 that is generated by the touch manipulations on the first GUI displayed on the TP 221 is input from the TP 221 to the control unit 400 via the TP coordinate communication line switch 401.

Next, explanations will be given for a case, shown in FIG. 4B, in which the TP coordinate communication line 461 is selected by the TP coordinate communication line switch 401, and the TP image line 462 is selected by the TP image line switch 402. The TP image signal 502 generated in the control unit 300 is input into the TP 221 via the TP image line switch 402, and the second GUI is displayed on the TP 221. The TP coordinate signal 501 that is generated by touch manipulations of the second GUI displayed on the TP 221 is input from the TP 221 to the control unit 300 via the TP coordinate communication line switch 401.

Next, explanations will be given for a case in which the first GUI transitions to the second GUI in response to the touch manipulations on the TP 221. The TP coordinate signal 501 generated by the touch manipulations on the TP 221 is sent to the control unit 400 in the MC 114. The control unit 400 that has received the TP coordinate signal 501 reports, to the control unit 300 in the NMC 202, that the first GUI will be switched to the second GUI. When receiving this report, the control unit 300 controls the TP control switching unit 305, and the switches 401 and 402 are operated so that the TP coordinate communication line 461 and the TP image line 462 on the NMC side are enabled. Then, the control unit 300 causes the TP 221 to display the second GUI via the TP image lines 462 and 472. Additionally, this process is also applied to the case in which the second GUI transitions to the first GUI in response to the touch manipulations.

The control unit 300 and the control unit 400 communicate with each other via the communication line 331 to monitor each other. Also, the control unit 300 and the control unit 400 synchronize with each other's GUI environment, and exchange information that has to be held by both of them for configuring a common GUI. An example of the above information is window elements (window element information such as tab names) to be used commonly.

As described above, the target to be controlled by the TP 221 is changed between the MC 114 and the NMC 202 on the basis of the switching operations of the TP control switching unit 305. This switching operation is not perceived by the users, and accordingly the users feel as if they have controlled only one controller.

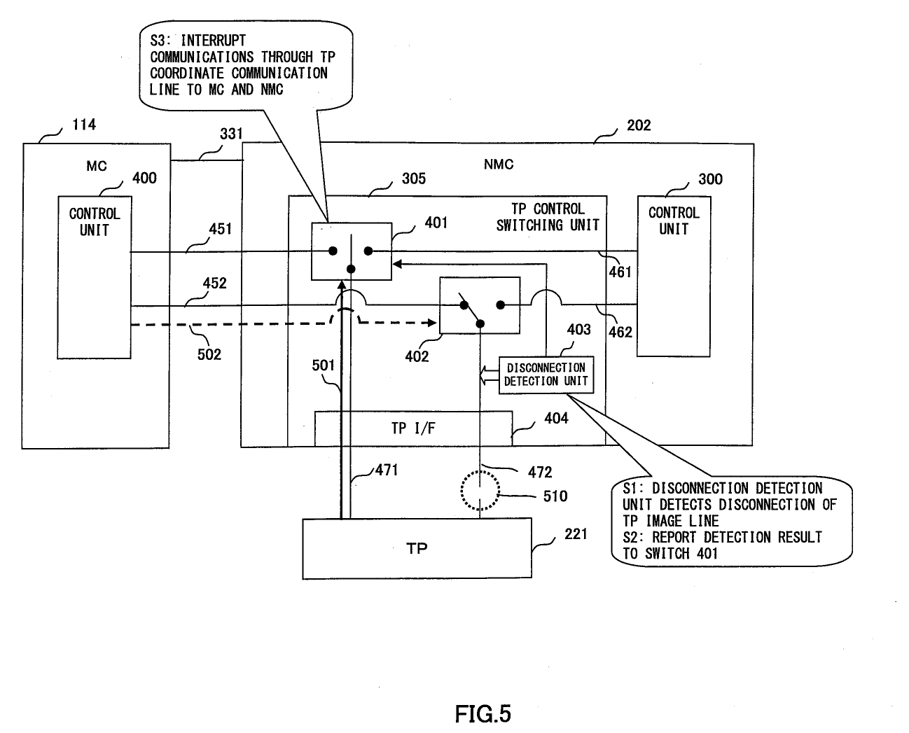

FIG. 5 shows, for the present embodiment, the interruption of communications through the TP coordinate communication line to the MC 114 and the NMC 202 when the TP image line is disconnected. For example, it is assumed that the TP image line 472 is disconnected, as pointed out by numeral 510 in the case of FIG. 5. In this case, the disconnection detection unit 403 detects the disconnection of the TP image line (S1), and reports this result to the TP coordinate communication line switch 401 (S2).

The switch 401, having received this report, interrupts the communications through the TP coordinate communication line to the MC 114 and the NMC 202 (S3). In other words, the switch 401 does not connect the TP coordinate communication line 471 to either the TP coordinate communication line 451 on the MC 114 side or the TP coordinate communication line 461 on the NMC 202 side.

As described above, the NMC 202 includes a detection unit (the disconnection detection unit 403) for detecting the abnormality of the image signal line used for outputting image signals to the TP 221 and an interruption unit (the switch 401) for interrupting communications with the medical device control device (MC 114). The interruption unit also interrupts the communications with the NMC 202 itself.

By the above configuration, when the TP image line 472 is disconnected, it is possible to interrupt the communications through the TP coordinate communication line. Accordingly, when the TP screen is blacked out due to the disconnection in the TP image line 472, it is impossible to control the MC 114 or the NMC 202 through the TP 221. Thus, when the screen of the TP 221 is blacked out due to the disconnection in the TP image line, it is possible to prohibit the manipulations of the medical devices connected to the MC 114 and the NMC 202.

The scope of the present invention is not limited to any of the above embodiments, and various other configurations and embodiments are allowed without departing from the spirit of the present invention.

As described above, it is possible to provide a medical support control device for controlling medical devices and non-medical devices.

What is claimed is:

1. A medical support control device to which are connected a display manipulation device and a medical device control device connected to a medical device and controlling the medical device, comprising:
a detection unit for detecting abnormality in an image signal line outputting an image signal to the display manipulation unit; and
an interruption unit for interrupting communications to the medical device control device in accordance with the detection unit.

2. The medical support control device according to claim 1, wherein:
the interruption unit is a switch device.

3. The medical support control device according to claim 1, wherein:
the interruption unit further interrupts communications to the medical support control device itself.

4. A medical support control system, comprising:
a medical device control device connected to a medical device and controlling the medical device;
a display manipulation device; and
a medical support control device to which the medical device control device and the display manipulation device are connected, wherein:
the medical support control device comprises:
a detection unit for detecting abnormality in an image signal line outputting an image signal to the display manipulation device; and
an interruption unit for interrupting communications to the medical device control device in accordance with the detection unit.

5. The medical support control system according to claim 4, wherein:
the interruption unit is a switch device.

6. The medical support control system according to claim 4, wherein:
the interruption unit further interrupts communications to the medical support control device itself.
